(19) United States
(12) Patent Application Publication
(10) Pub. No.: US 2006/0061837 A1
(43) Pub. Date: Mar. 23, 2006

(54) CLAMP FOR FIXING A PHOTOGRAPHIC SLIDE OR NEGATIVE

(76) Inventors: Kuo-Ching Huang, Taipei City (TW); Yu-Cheng Chang, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 10/904,740

(22) Filed: Nov. 24, 2004

(30) Foreign Application Priority Data
Sep. 22, 2004 (TW) 093128741

(51) Int. Cl. H04N 1/23

(52) U.S. Cl. 358/487; 358/302

(57) ABSTRACT

A clamp for fixing a photographic slide and/or a photographic negative includes a carrier and a cover for fixing the slide or negative onto the carrier. The carrier includes a first guide for holding the negative, and a second guide extended from the first guide for holding the photographic slide.

### BACKGROUND OF INVENTION

1. Field of the Invention

The present invention relates to a clamp, and more particularly, to a clamp for fixing a photographic slide and/or negative.

2. Description of the Prior Art

With digital technology advancements, more image information is stored in a digital manner. For instance, an image processing device can be used for scanning image information of traditional image media, such as flat photographs, transparencies, rolls of film, such that image information of traditional image media can be processed in a computer. In addition, a transmissive scanner can be used for scanning transparent documents, such as transparencies and films. The transmissive scanner sends light through the transparent document so as to transform the image of the transparent document into digital data by the image processing device.

In the prior art, a film clamp is used for fixing a photographic slide or negative when the image processing device scans a transparent document. There are two methods for scanning a transparent document. One involves the film clamp being placed on a transparent platform of the image processing device for fixing the position of the film clamp. The other requires the film clamp to be assembled on a backlight plate of the image processing device.

Generally, different kinds of transparent documents use different kinds of film clamps. Please refer to FIG. 1. FIG. 1 is a diagram of a negative clamp 100 according to the prior art. The negative clamp 100 comprises a carrier 110 and a cover 120. The carrier 110 includes a negative guide 112 for carrying a long slice negative. After the negative is placed on the carrier 110, the cover 120 fixes the negative by engaging to the carrier 110. Please refer to FIG. 2. FIG. 2 is a diagram of a slide clamp 200 based on the prior art. The slide clamp 200 comprises a carrier 210 having a plurality of photographic slide guides 212, such that the carrier 210 is capable of simultaneously holding a plurality of photographic slides. After the photographic slides are laid on the carrier 210, the slide clamp 200 is placed on the transparent platform of the image processing device, or connected to the backlight plate of the image processing device for scanning.

Next, please refer to FIG. 3, which is a diagram of a clamp 300 for fixing photographic slides and a negative according to the prior art. The clamp 300 includes the negative clamp 100 of FIG. 1 and the slide clamp 200 of FIG. 2. That is, the clamp 300 can be divided into two parts. One is similar to the negative clamp 100 for fixing the negative. The other is similar to the slide clamp 200 for fixing photographic slides. Due to different shapes and sizes of photographic slides and negatives, the placement positions of the photographic slide and the negative are separated. The structure of the clamp 300 is similar to the clamps 100 and 200 and further description of their details is omitted.

Due to differences in shape and size between a photographic slide and a negative, clamps for holding a photographic slide and a negative are separately designed in the prior art. The user utilizes the negative clamp 100 to scan a negative and the slide clamp 200 to scan a photographic slide. However, costs in making two separate devices is high, and it can also be bothersome to the user to have to gather together all kinds of auxiliary scanning elements. Although the combined clamp 300 is available to the user, the cost and complexity of the clamp 300 is the same as the clamps 100 and 200.

Additionally, some manufacturers combine a film clamp with the backlight plate of the image processing device. However, this type of film clamp is still limited due to different shapes and sizes of photographic slides and negatives. The clamps combined with the backlight plate of the image processing device are typically the two kinds of clamps 100 and 200. And so, when scanning a transparent document, the required clamp is chosen based on the kind of the transparent document.

The prior art uses different designs of clamps 100, 200, or 300, which have their drawbacks. That is, the cost and complexity are high and often more than one specialized clamp is required. Therefore, we need a clamp for fixing the slide or negative that has low cost and complexity and is convenient to use.

### SUMMARY OF INVENTION

It is therefore a primary objective of the claimed invention to provide a clamp for fixing a photographic slide or negative to solve the above-mentioned problems.

The claimed invention discloses a clamp for fixing a photographic slide or negative. The clamp includes a carrier and a cover for fixing the photographic slide or negative on the carrier. The carrier includes a first guide for holding the negative, and a second guide for holding the photographic slide. Especially, the first guide and the second guide have an overlapping area.

The claimed invention further discloses an image processing device capable of processing a photographic slide or negative. The image processing device includes a backlight plate and a clamp installed on the backlight plate in a detachable manner. The clamp includes a carrier and a cover for fixing the photographic slide or negative on the carrier. The carrier includes a first guide for holding the negative, and a second guide for holding the photographic slide. Especially, the first guide and the second guide have an overlapping area.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a negative clamp of the prior art.

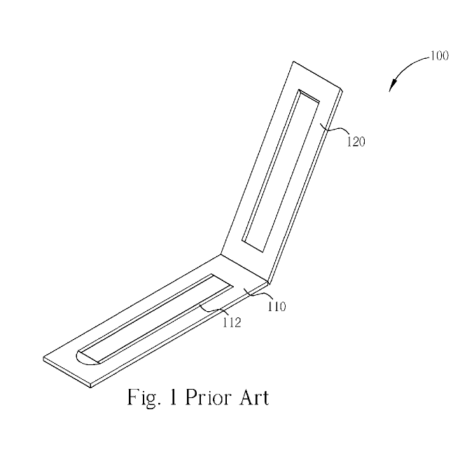

FIG. 2 is a diagram of a slide clamp of the prior art.

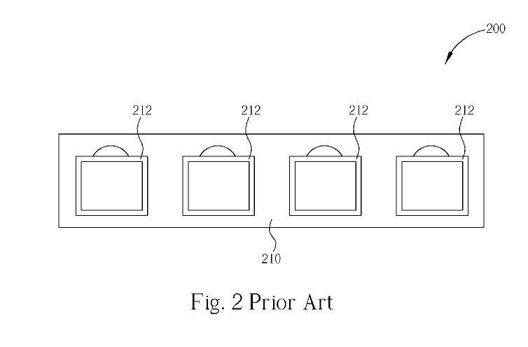

FIG. 3 is a diagram of a clamp for fixing a photographic slide and a negative according to the prior art.

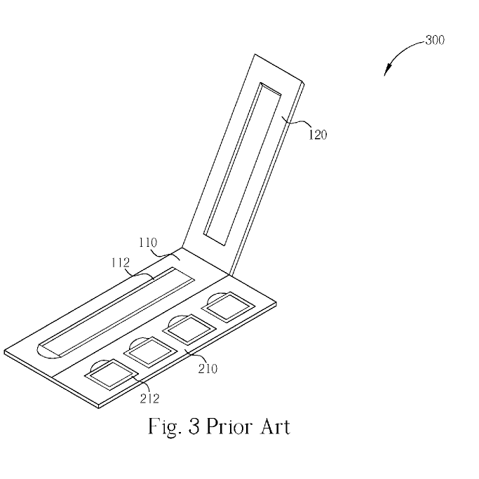

FIG. 4 is a diagram of a clamp for fixing a photographic slide or negative according to the present invention.

FIG. 5 is a diagram of a carrier of the present invention.

FIG. 6 is a diagram of holding the photographic slide on the carrier based on the present invention.

FIG. 7 is a diagram of holding the negative on the carrier based on the present invention.

FIG. 8 is a diagram of a cover of the present invention.

FIG. 9 is a cross-sectional diagram along line 9-9′of FIG. 8.

FIG. 10 is an enlarged diagram of a region A of FIG. 9.

FIG. 11 is a cross-sectional diagram of after the carrier engages to the cover according to the present invention.

FIG. 12 is a diagram of a flexible arm set on the cover of the present invention.

FIG. 13 is a diagram of the flexible arm without the photographic slide in the clamp according to the present invention.

FIG. 14 is a cross-sectional diagram of fixing the photographic slide using the flexible arm according to the present invention.

FIG. 15 is a diagram the clamp of the present invention assembled with the backlight plate of the image processing device.

### DETAILED DESCRIPTION

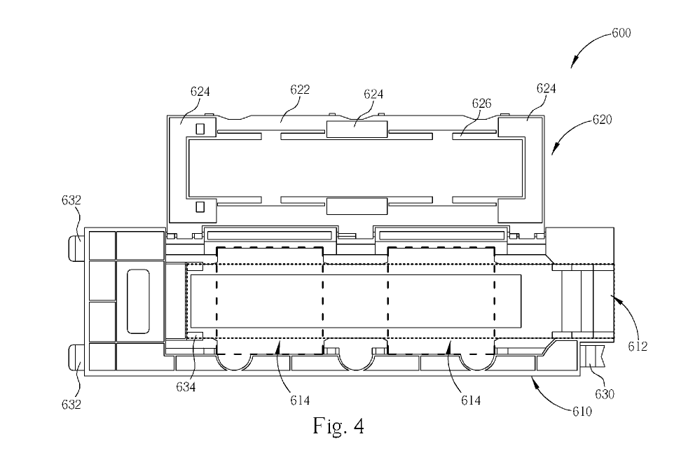

Please refer to FIG. 4, which is a diagram of a clamp 600 for fixing a photographic slide or negative according to the present invention. The clamp 600 comprises a carrier 610 and a cover 620. The cover 620 is hinged to the carrier 610. The carrier 610 includes a first guide 612 for holding the negative, and two second guides 614 for holding photographic slides. The cover 620 includes a plate 622 for fixing the photographic slide on the second guide 614 when the cover 620 engages the carrier 610. Generally, the transparent film of a photographic slide is placed between cardboard. Therefore, the thickness of the photographic slide is thicker than that of the negative. The cover 620 of the present invention further includes a raised rim 624 for firmly fixing the negative on the first guide 612 when the cover 620 engages the carrier 610. As shown in FIG. 4, the raised rim 624 is used for holding the negative. The details will be described later.

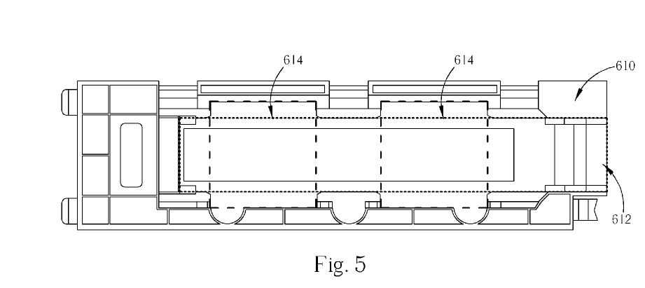

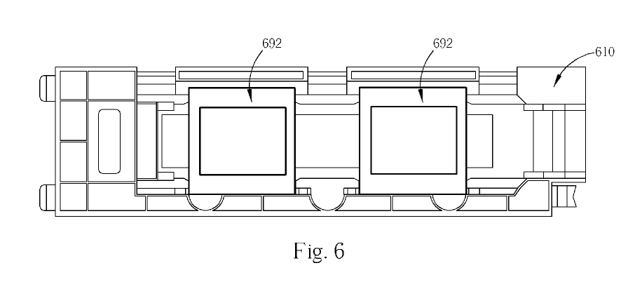

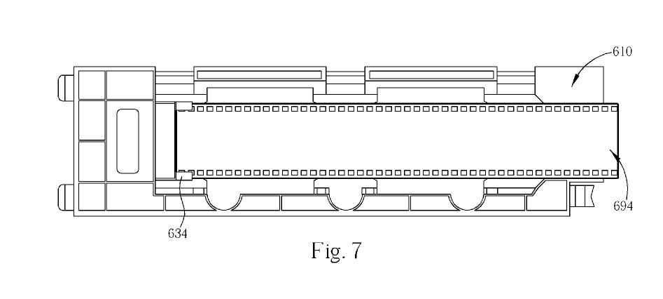

First, we discuss how the photographic slide and the negative are placed on the clamp 600 of the present invention. Please refer to FIG. 5 to FIG. 7. FIG. 5 is a diagram of the cover 610. FIG. 6 and FIG. 7 are diagrams of laying the photographic slide and the negative on the carrier 610, respectively. From the dotted lines in FIG. 5, it is clear that the size of the negative is narrower than the size of the photographic slide, so thus, both sides of the first guide 612 are extended to form the second guide 614. Photographic slides 692 are placed on the second guides 614 for scanning, as shown in FIG. 6. Likewise, a long slice negative 694 is placed on the first guide 612. In addition, the carrier 610 further includes two clips 634 for engaging an end of the negative 694 to prevent the negative 694 from moving, as shown in FIG. 7.

The present invention extends part of the first guide 612 to form the second guide 614, such that the first guide 612 and the second guide 614 have an overlapping area to reduce the total area of the clamp 600. Compared to the clamp 300 of the prior art, the clamp 600 of the present invention cannot only fix a photographic slide, but also a negative. Moreover, the size of the clamp 600 is just half of the clamp 300. The size of clamp 600 is similar to the sizes of the clamps 100 and 200. However, the clamp 600 can hold both a photographic slide and a negative while the clamps 100 and 200 can only hold a photographic slide or a negative, respectively. Therefore, possible applications of the clamp 600 are increased.

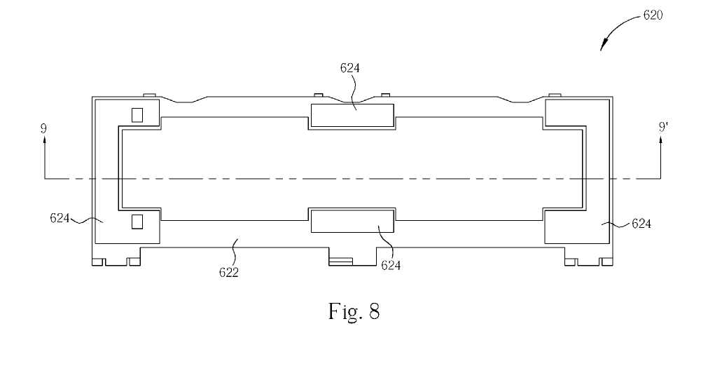

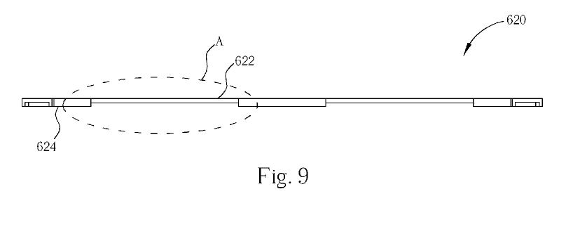

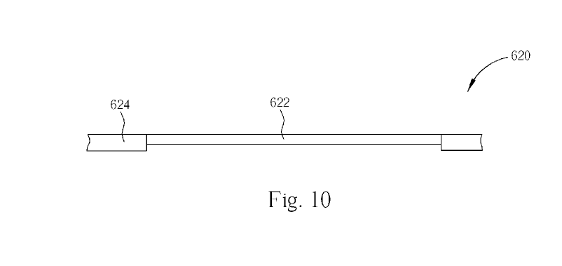

Now, we discuss how the photographic slide and the negative are fixed in the clamp 600 of the present invention. The present invention provides another embodiment. Please refer to FIG. 8 to FIG. 10. FIG. 8 is a diagram of the cover 620. FIG. 9 and FIG. 10 are cross-sectional diagrams of the cover 620. The clamp 600 has the ability to fix a photographic slide and a negative regardless of the fact that the thickness of the photographic slide, including the thickness of cardboard, is thicker than that of the negative. That is, the regions of the plate 622 of the cover 620 and the raised rim 624 shown in FIG. 8 are used to respectively fix the photographic slide and the negative. Please refer to FIG. 9. FIG. 9 is a cross-sectional diagram along line 9-9′ of FIG. 8. The plate 622 is used for fixing the photographic slide while the raised rim 624 is used for fixing the negative. An enlarged region A in FIG. 9 is shown in FIG. 10. From FIG. 10, the difference of the thickness of the plate 622 and the raised rim 624 can be seen clearly.

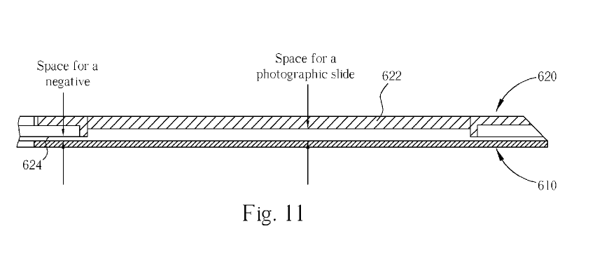

As for designs of the cover 620 and the carrier 610 mentioned above, after the carrier 610 engages the cover 620, there are two spaces with different thickness, as shown in FIG. 11. One space is for placing the photographic slide and the other for placing the negative. Therefore, the clamp 600 of the present invention can fix both photographic slides and negatives regardless of their differing thickness.

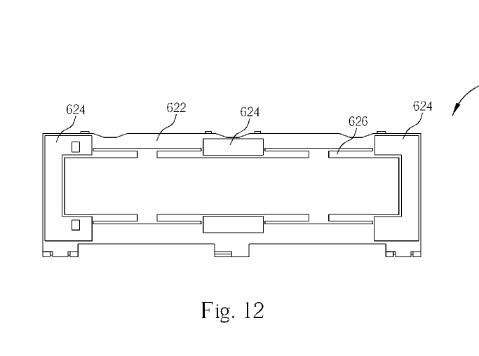

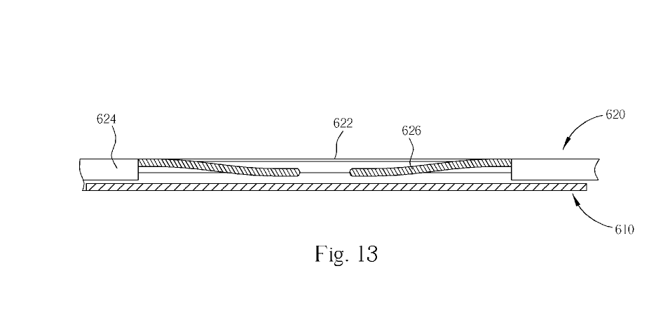

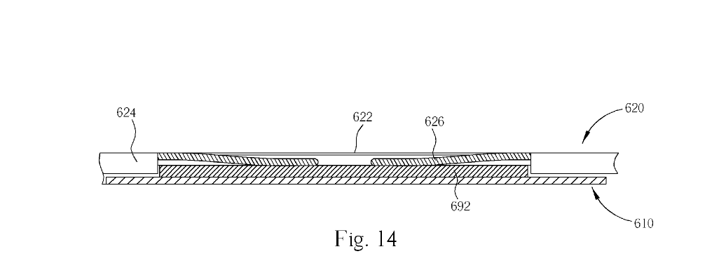

In addition, there is an allowable tolerance for the thickness of cardboard of photographic slides. However, the plate 622 of the cover 620 may not be flexible to fix all different thickness of photographic slides due to the tolerance, and thus a photographic slide might move a little while being fixed in the clamp 600. In order to address this issue, the plate 622 of the cover 620 further includes flexible arms 626. Please refer to FIG. 12, which is a diagram of the flexible arms 626 of the cover 620. Next, please refer to FIG. 13, which is a diagram of a flexible arm 626 without the photographic slide in the clamp 600. The flexible arm 626 is slack when there is no photographic slide fixed in the clamp 600. Please refer to FIG. 14. When the photographic slide 692 is placed on the second guide 614 and after the cover 620 engages to the carrier 610, the state of the flexible arm 626 is tight as shown in FIG. 14. The flexible arm 626 can automatically adjust so as to firmly fix the photographic slide 692 according to the real thickness of the photographic slide 692. Therefore, the present invention can automatically compensate for the tolerance of cardboard thickness.

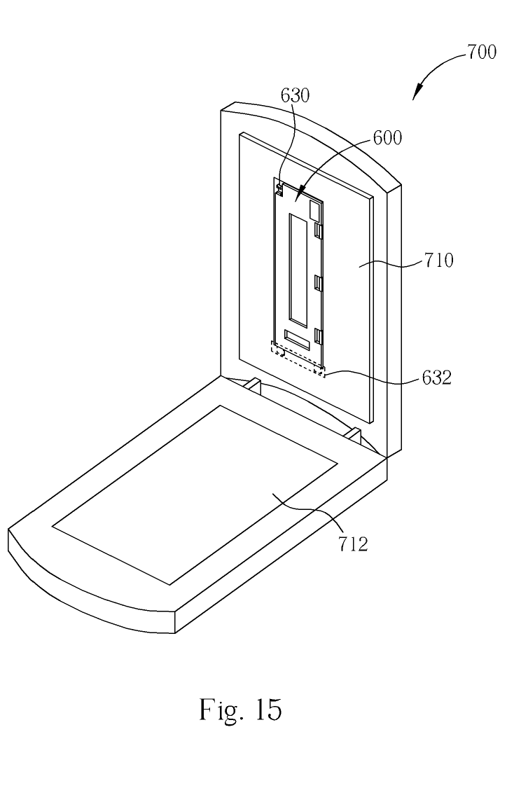

The clamp 600 further comprises engaging members or locks for engaging the clamp 600 to a backlight plate of an image processing device. Please refer to FIG. 4 again. The clamp 600 includes a lock 630 and two engaging members 632. Please refer to FIG. 15. An image processing device 700 comprises a transparent platform 712 and a scanning module (not shown in FIG. 15) for scanning the photographic slide or negative. The clamp 600 of the present invention engages a backlight plate 710 of the image processing device 700 through the lock 630 and the two engaging members 632. In addition, the engaging members 632 or the lock 630 of the clamp 600 are not limited to the example of FIG. 4. Other kinds of elements capable of fixing the clamp 600 onto the backlight plate 710 of the image processing device 700 can be implemented in the present invention.

The clamp 600 is just an example of the present invention. According to requirements, the clamp 600 can be designed to hold any quantity or size of photographic slides and negatives, such as 35 mm negatives, 35 mm photographic slides, 120/220(6×9 cm) film, 4×5 inch films, etc. The clamp 600 of the present invention can be implemented in different kinds of image processing devices, such as a scanner, printer, fax machine, or a combination of these devices.

Compared to the prior art, the clamp 600 of the present invention utilizes the overlapping area of the second guide 614 and the first guide 612 to shrink the overall size needed to fix photographic slides and/or negatives. The cover 620 is designed to fix different thickness of photographic slides and negatives. In addition, the cover 620 includes flexible arms 626 capable of compensating for tolerances in thickness of photographic slides. Moreover, the engaging members 632 and the lock 630 of the clamp 600 are used for engaging the clamp 600 to the backlight plate 710 of the image processing device 700. When the image processing device 700 is not used, the clamp 600 can be fixed on the backlight plate 710 of the image processing device 700, to prevent a user from misplacing the clamp 600. The present invention not only solves the problem of losing the clamps 100, 200, and 300, but also reduces the cost and complexity of design.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A clamp for fixing a photographic slide or negative comprising:
a carrier having a first guide for holding a negative, and a second guide for holding a slide; and
a cover for fixing the slide or negative on the carrier;
wherein the first guide and the second guide have an overlapping area.

2. The clamp of claim 1 wherein the second guide is extended from the first guide.

3. The clamp of claim 1 wherein the cover includes a raised rim for fixing the negative onto the carrier.

4. The clamp of claim 1 wherein the cover includes a flexible arm for elastically pressing the slide against the carrier.

5. The clamp of claim 1 wherein the carrier includes two engaging members for engaging the clamp to a backlight plate of an image processing device.

6. The clamp of claim 5 wherein the image processing device is a scanner, printer, or fax machine, or a combination of these devices.

7. The clamp of claim 5 wherein the image processing device further comprises a transparent platform and a scanning module for scanning the slide or negative.

8. The clamp of the claim 1 wherein the cover is hinged to the carrier.

9. An image processing device for processing a photographic slide or negative comprising:
a backlight plate; and
a clamp installed on the backlight plate in a detachable manner, the clamp comprising:
a carrier having a first guide for holding a negative, and a second guide for holding a slide; and
a cover for fixing the slide or negative on the carrier;
wherein the first guide and the second guide have an overlapping area.

10. The image processing device of claim 9 wherein the second guide is extended from the first guide.

11. The image processing device of claim 9 being a scanner, printer, or fax machine, or a combination of these devices.

12. The image processing device of claim 9 wherein the carrier includes a clip for engaging an end of the negative.

13. The image processing device of claim 9 wherein the cover includes a raised rim for fixing the negative onto the carrier.

14. The image processing device of claim 9 wherein the cover includes a flexible arm for elastically pressing the slide against the carrier.

15. The image processing device of claim 9 wherein the carrier includes two engaging members, and the backlight plate includes two corresponding engaging members for engaging the two engaging members of the carrier to connect the clamp with the backlight plate.

16. The image processing device of claim 9 wherein the cover is hinged to the carrier.

17. The image processing device of claim 9 further comprising a transparent platform and a scanning module for scanning the slide or negative.
